(19) United States
(12) Patent Application Publication
(10) Pub. No.: US 2008/0234891 A1
(43) Pub. Date: Sep. 25, 2008

(54) DEVICE AND METHOD FOR DETECTING ERROR OF STEERING ANGLE SENSOR

(76) Inventor: Jae Woo PYO, Seoul (KR)

Correspondence Address: IPLA P.A., 3580 WILSHIRE BLVD., 17TH FLOOR, LOS ANGELES, CA, 90010, US

(21) Appl. No.: 12/052,461

(22) Filed: Mar. 20, 2008

(30) Foreign Application Priority Data
Mar. 20, 2007 (KR) 10-2007-0026929

(51) Int. Cl. G01M 17/00

(52) U.S. Cl. 701/35; 701/29

(57) ABSTRACT

Provided is a steering angle sensor error detecting device comprising: steering angle sensor comprised of the first and the second sensor which sense the angle of the steering device; A/D converter which converts the steering angle signal from the first sensor and the second sensor into digital signal; steering angle computation unit which computes steering angles from the steering angle signals which are converted into digital signal; and steering angle error detecting unit which detects error of the steering angle signals by comparing the computed steering angles.

### CROSS REFERENCE

This application claims foreign priority under Paris Convention and 35 U.S.C. §119 to Korean Patent Application No. 10-2007-0026929, filed Mar. 20, 2007 with the Korean Intellectual Property Office.

### TECHNICAL FIELD

The present invention relates to device and method for detecting error of steering angle sensor which detects rotational angle of the steering device in a vehicle by computing and checking steering angle of the steering angle sensor, especially to device and method for detecting error of the steering angle sensor, which prevents error caused by noise in steering angle signal from the steering angle sensor.

### BACKGROUND ART

Generally, a device used for changing direction of a vehicle is called as steering device.

This steering device operates in a manner that when a driver operates a steering wheel usually called as handle, its rotation is transmitted to a gear device through a steering shaft, and then the gear device moves a driving shaft and driving device which are connected with wheels and thus the wheels are moved in the desired direction.

Most of the vehicles produced recently are installed with a power steering system.

The power steering system makes the operation of the steering device easier by using the driving power of engine according to the steering angle of the steering wheel.

The power steering system is provided with a steering angle sensor which measures rotational angle of the steering wheel and a steering angle measuring device which is comprised of computation unit computing the measured value which is measured by the steering angle device and etc, wherein regarding the measurement of rotational angle of the steering wheel by the steering angle sensor, steering gear and pinion gear of the steering angle sensor connected with the steering wheel of the vehicle measure the rotational angle of the steering wheels and output it as steering angle signal.

And the steering angel measuring device of the art derives the rotational angle by having the steering angle signal which is outputted by the steering angle sensor processed in the computation unit and computes rotational angle of the steering device based upon the rotational angle.

In the steering angel measuring device whose constitutions are described in the above, in case distortion in the measured signal occurs due to disturbance exterior to the vehicle, badness or break down of components interior of the vehicle, the constitution for avoiding the distortion is not sufficiently provided, so that problems could take place such as the vehicle malfunctions when operated on the basis of the computed value which is computed from the erroneous steering angle caused by the distorted signal, or electronic devices which make use of the computed value are subject to undesirable problems.

### Disclosure

### Technical Problem

Thus, the purpose of the present invention is to provide the device and the method for detecting error in the steering angle sensor which can decide whether or not error exists in the steering angle signal measured by the steering angle sensor through an algorithm which can detect error by comparing the steering angle signal measured by the first sensor with the steering angle signal measured by the second sensor in the course of computation of the steering angle.

### Technical Solution

The purpose is achieved through the steering angle sensor error detecting device according to the present invention comprising: steering angle sensor comprised of the first and the second sensor which sense the angle of the steering device; A/D converter which converts the steering angle signals from the first sensor and the second sensor into digital signals; steering angle computation unit which computes steering angles from the steering angle signals which are converted into digital signals; and steering angle error detecting unit which detects error of the steering angle signals by comparing the computed steering angles.

Wherein the steering angle computation unit computes the steering angles through the following equations:

θₜₐₙ=arctan(V₁/−V₂), θₛᵢₙ=arcsin(V₁), θ_{cos}=arccos(−V₂),

and the steering angle computation unit detects the error of the steering angle signals by checking out whether or not the computed steering angles satisfy the relation of θₜₐₙ=θₛᵢₙ=θ_{cos}(θₜₐₙ: basic steering angle, θₛᵢₙ: the first sensor steering angle, θ_{cos}: the second sensor steering angle, V1: the first sensor steering angle signal, V2: the second sensor steering angle signal).

Further, the steering angle error detecting unit computes error value E1, E2 through the following equations:

E₁=θₜₐₙ−θₛᵢₙ

E₂=θₜₐₙ−θ_{cos},

and further comprises an algorithm through which the error of the steering angle signals is detected based upon the error value E1, E2 (E1: the first sensor error value, E2: the second sensor error value, θₜₐₙ: basic steering angle, θₛᵢₙ: the first sensor steering angle, θ_{cos}: the second sensor steering angle).

The steering angle error detecting unit desirably further comprises a truth table in which the error tolerance range of the steering angles in accordance with the change of the amplification of the steering angle sensor and the change of the signal offset of the steering angle sensor is shown, and an algorithm through which the error of the steering angle signals is detected based upon the truth table.

Further, the steering angle error detecting unit computes the optimized state decision value D through the following equation:

D=|Eₐ|−|E_{b}|,

and further comprises an algorithm through which the optimized state of the steering angle signals is decided based upon the decision value D (Eₐ: the error value with higher accuracy of E1 and E2, E_{b}: the error value with lower accuracy of E1 and E2, D: decision value of the optimized state).

Still further, the steering angle error detecting unit further comprises a registry where the signal value of the previous steering angle signals is memorized and transmits the varied steering angle value of the previous steering angle signal memorized in the registry to the computation unit in case the steering angle signal is decided to be erroneous, and the computation unit computes the estimated value of the steering angle based upon the varied steering angle value.

The steering angle error detecting unit desirably stops the operation of the steering angle sensor in case the error of the steering angle signal lasts for predestined time interval or longer.

Meanwhile, the purpose is also achieved through the steering angle sensor error detecting method according to the present invention comprising: a step in which the angle of the steering device is sensed by steering angle sensor and the steering angle signal is generated; a step in which the steering angle signal is converted into digital signal by A/D converter; a steering angle computing step in which the steering angle is computed from the steering angle signal converted into digital signal by steering angle computation unit; and a steering angle error detecting step in which the error of the steering angle signal is detected by comparing the computed steering angle in the steering angle error detecting unit.

Wherein in the steering angle computing step, the steering angles are computed through the following equations:

θₜₐₙ=arctan(V₁/−V₂), θₛᵢₙ=arcsin(V₁), θ_{cos}=arccos(−V₂),

and in the steering angle error detecting step, the error of the steering angle signals is detected by checking out whether or not the computed steering angles satisfy the relation of θₜₐₙ=θₛᵢₙ=θ_{cos}.

Further, in the steering angle error detecting step, the error value E1, E2 is computed through the following equations:

E₁=θₜₐₙ−θₛᵢₙ

E₂=θₜₐₙ−θ_{cos},

and the step further comprises an algorithm through which the error of the steering angle signal is detected based upon the error value E1, E2.

The steering angle error detecting step desirably further comprises a truth table in which the error tolerance range of the steering angle in accordance with the change of the amplification of the steering angle sensor and the change of the signal offset of the steering angle sensor is shown, and an algorithm through which the error of the steering angle signal is detected based upon the truth table.

Further, in the steering angle error detecting step, the optimized state decision value D is computed through the following equation:

D=|Eₐ|−|E_{b}|,

and the step further comprises an algorithm through which the optimized state of the steering angle signals is decided based upon the decision value D.

Still further, the steering angle error detecting unit further comprises a registry where the signal value of the previous steering angle signal is memorized and transmits the varied steering angle value of the previous steering angle signal memorized in the registry to the computation unit in case the steering angle signal is decided to be erroneous, and a step is further comprised in which the computation unit computes the estimated value of the steering angle based upon the varied steering angle value.

The steering angle error detecting step desirably further comprises a step in which the operation of the steering angle sensor is stopped in case the error of the steering angle signal lasts for the predestined time interval or longer.

### Advantageous Effects

As described in the above, thanks to the device and method for detecting error of steering angle sensor according to the present invention, it is possible to decide whether or not the steering angle signal measured by the steering angle sensor is erroneous through an algorithm wherein the steering angle signals measured by the first sensor and the second sensor of the steering sensor are compared with each other in the course of the computation of the steering angle, so that error can be detected.

### DESCRIPTION OF DRAWINGS

FIG. 1 shows block diagram which illustrates the constitution of the error detecting device for steering angle sensor according to the present invention.

FIG. 2 shows wave pattern of the output which is measured by the steering angle sensor.

FIG. 3 shows flow chart illustrating the procedure of detecting the steering angle of one embodiment of the error detecting device for steering angle sensor according to the present invention.

FIG. 4 shows flow chart illustrating the algorithm for detecting the error in the steering angle of the one embodiment of the error detecting device for steering angle sensor according to the present invention.

Reference numerals of the primary elements in the attached drawings

| | |
|---|---|
| 11: the first sensor | 12: the second sensor |
| 13: the first sensor amplifying unit | 14: the second sensor amplifying unit |
| 21: A/D converter | 23: steering angle computation unit |
| 25: steering angle error detecting | 27: steering angle outputting unit |
| unit | |

### Best Mode

Hereinafter, the embodiment of the present invention is to be described in detail referring to the attached drawings.

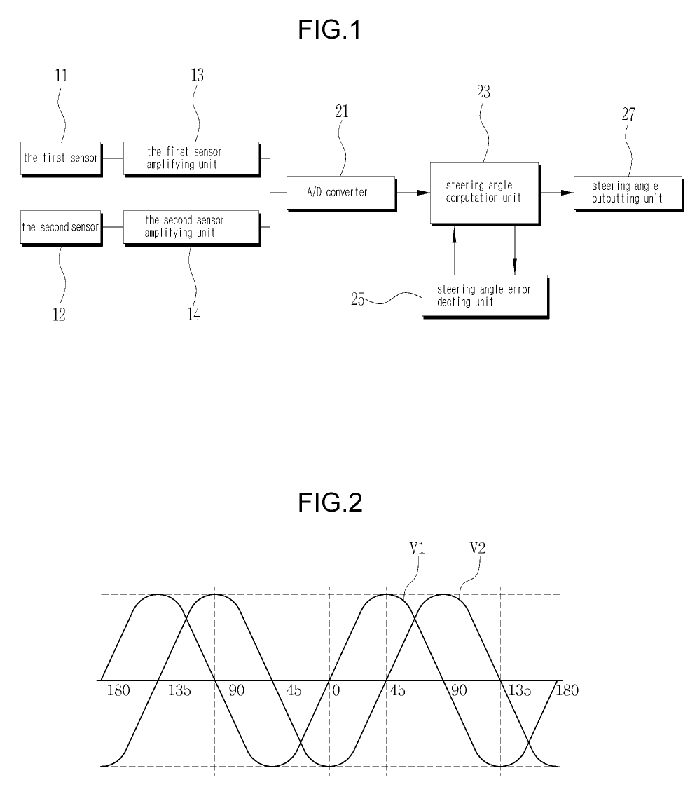

FIG. 1 shows block diagram which illustrates the constitution of device for detecting error in the steering angle sensor according to the present invention.

Referring to FIG. 1, the device for detecting error in the steering angel sensor according to the present invention comprises steering angle sensor which is comprised of the first sensor and the second sensor 11, 12 provided in the steering angle sensor device (not shown in the figure), the first sensor and the second sensor amplifying unit 13, 14, A/D converter 21, steering angle computation unit 23, steering angle error detecting unit 25 and steering angle outputting unit 27.

The first sensor and the second sensor 11, 12, which are for sensing the rotational angle of the steering wheel, respectively, generate steering angle signal V1, V2 according to the rotational angle of the steering gear and the pinion gear which are provided in the steering angle sensor device, wherein the rotational angle of the steering wheel is computed from the steering angle signal V1, V2.

In this regard, the first sensor and the second sensor 11, 12 generate the steering angle signal V1, V2 which are shown in the waveform of trigonometrical function according to the rotation of the steering wheel as shown in FIG. 2, wherein the phase difference between the steering angel signal V1 and V2, which are sensed by the first sensor and the second sensor 11, 12, is 90°.

Therefore, the functional relation between the steering angle signal V1 and the steering angle V2, which are sensed by the first sensor and the second sensor, respectively, corresponds to that between sine and -cosine, and the steering angle θₜₐₙ computed based upon the two steering angle signals V1, V2, which are sensed by the first sensor 11 and the second sensor 12, respectively, is computed through the following equation:

θₜₐₙ=arctan(V₁/−V₂) equation (1)

The computation is performed by the steering angle computation unit 23 which is provided in the control part, wherein the steering angle computation unit 23 includes the first sensor amplifying unit 13 and the second sensor amplifying unit 14 which amplify the steering angle signals V1, V2 generated by the first sensor 11 and the second sensor 12 for the computation by the steering angle computation unit 23, and the A/D converter which converts the amplified steering angle signals V1, V2 into digital signal as its constitutional elements.

Meanwhile, the device for detecting error in the steering angel sensor according to the present invention comprises the steering angle error detecting unit 25 which decides whether or not the steering angle is erroneous which is computed by the steering angle computation unit 23.

The steering angle error detecting unit 25 decides whether or not the steering angle based upon the steering angle signal V1 and V2 from the first sensor and the second sensor 11, 12 is identical with each other, then decides whether or not the steering angle is erroneous based upon the steering angle signal V1, V2 from the first sensor and the second sensor 11, 12 through the algorithm of the error detecting method according to the present invention which are to be described in the below, and then stops the operation of the control device or electronic device which operates based upon the steering angle in case the error lasts for predestined time interval or longer.

In this regard, according to the error detecting method adopted by the error detecting unit 25, the steering angle computed through the equation (1) based upon the steering angle signal V1, V2 generated by the first sensor and the second sensor 11, 12, the steering angle computed through the following equation based upon the steering angle signal V1, V2 generated by the first sensor 11 and the steering angle computed through the following equation based upon the steering angle signal V1, V2 generated by the second sensor 12 are compared with one another:

θₛᵢₙ=arcsin(V₁) equation (2)

θ_{cos}=arccos(−V₂) equation (3)

wherein in case the result acquired by the comparison of the steering angles θₜₐₙ, θₛᵢₙ, θ_{cos} which are computed through the equations (1), (2) and (3) is not θₜₐₙ=θₛᵢₙ=θ_{cos}, the signal generated by the steering angle sensor can be recognized as erroneous.

Since the steering angle signal V1, V2, in general, is subject to error to a certain degree due to the property change such as change in the amplification rate of the steering angle sensor 11, 12 and the change in the signal offset of the steering angle sensor 11, 12, there could be a case where the computed steering angles are not identical with one another even if the signal is normal.

In this regard, it can be decided whether or not the steering angle signal falls within normal range through the following equations:

sin(θₛᵢₙ)=sin(θ₁)×cos(e1-1)±e1-2 equation (4)

−cos(θ_{cos})=−cos(θ₂)×cos(e2-1)±e2-2 equation (5)

wherein, θₛᵢₙ means the steering angle computed based upon the steering angle signal V1, θ₁ means the ideal steering angle which can be computed when the steering angle signal V1 is free of error, θ_{cos} means the steering angle computed based upon the steering angle signal V2, and the θ₂ means the ideal steering angle which can be computed when the steering angle signal V2 is free of error.

Further, e1-1 and e2-1 mean the change in the amplification rate of the steering angle sensor 11, 12, respectively, while e1-2 and e2-2 mean the change in the signal offset of the steering angle sensor 11, 12, respectively.

Since, in general, the computation unit 23 which computes the steering angle does not measure or control this property change e1-1, e2-1, e1-2 and e2-2 separately, the compensated angle and error tolerance range of the steering angle are computed on the basis of the θₜₐₙ which is computed through the equation (1) instead.

In this regard, in case the steering angles θₜₐₙ, θₛᵢₙ, θ_{cos} are not identical with one another, error value E1 of the first sensor 11 and error value E2 of the second sensor 12 are computed through the following equations:

E₁=θₜₐₙ−θₛᵢₙ equation (6)

E₂=θₜₐₙ−θ_{cos} equation (7)

Further, the steering angle sensor error detecting device according to the present invention realizes the algorithm which utilizes the equations (4) and (5), and detects error in the steering angle sensor by utilizing the following truth table(table 1) wherein resulting values regarding the error tolerance range of the steering angles θₛᵢₙ and θ_{cos}, which are measured by the steering angle sensors 11 and 12 and computed on the basis of the steering angle θₜₐₙ through the simulation of the algorithm, are shown.

TABLE 1

| | Area | | | | | | | |
|---|---|---|---|---|---|---|---|---|
| | 0~22.5 | 22.5~45 | 45~67.5 | 67.5~90 | 90~112.5 | 112.5~135 | 135~157.5 | 157.5~180 |
| Tolerance range | 5.2 | 13.7 | 32.7 | 35.2 | 35.2 | 32.7 | 13.7 | 5.2 |
| (θₛᵢₙ) | | | | | | | | |
| Tolerance range | 35.2 | 32.7 | 15.7 | 5.2 | 5.2 | 13.7 | 32.7 | 35.2 |
| (θ_{cos}) | | | | | | | | |
| Prioritized signal | sinθ | Sinθ | cosθ | cosθ | cosθ | cosθ | sinθ | Sinθ |
| | Area | | | | | | | |
| | 180~202.5 | 202.5~225 | 225~247.5 | 247.5~270 | 270~292.5 | 292.5~315 | 315~337.5 | 337.5~360 |
| Tolerance range | 5.2 | 13.7 | 32.7 | 35.2 | 35.2 | 32.7 | 13.7 | 5.2 |
| (θₛᵢₙ) | | | | | | | | |
| Tolerance range | 35.2 | 32.7 | 13.7 | 5.2 | 5.2 | 13.7 | 32.7 | 35.2 |
| (θ_{cos}) | | | | | | | | |
| Prioritized signal | sinθ | Sinθ | cosθ | cosθ | cosθ | cosθ | sinθ | Sinθ |

Wherein, if the error value derived through the equations (6) and (7) falls within the error tolerance range shown in the truth table(table 1), the computed steering angle signal V1, V2 is decided to be normal, whilst if out of the error tolerance range, the computed steering angle signal V1, V2 is decided to be erroneous bad signal.

In the mean time, since even the normal steering angle signal includes erroneous value within the error tolerance range and the error range of the steering angle signal is of structure in which the two signal are alternated by the area with high accuracy and the area with low accuracy on the basis of the steering angle θₜₐₙ, the optimized state of the steering angle signal can be decided through the difference between the error value E1 of the steering angle signal V1 from the first sensor 11 and the error value E2 of the steering angle signal V2 from the second sensor 12.

With regard to the decision of the optimized state of the steering angle signal, defining that the steering angle with higher accuracy of the computed steering angles θₛᵢₙ, θ_{cos} is θₐ, the steering angle with lower accuracy is θ_{b}, the error value of θₐ is Eₐ, and the error value of is θ_{b} is E_{b}, the state is decided to be optimized state in case the signal of θ_{b} at the normal state is close to the signal error of θₐ or less than θₐ.

Thus, the decision value D is derived through the following equation through which the optimized state of the steering angle signal is derived:

D=|Eₐ|−|E_{b}| equation (8)

wherein, if the decision value D computed through equation (8) is higher than 0, the steering angle signal V1, V2 is decided to be at erroneous state, while the decision value D is 0 or less, the steering angle signal V1, V2 is decided to be at normal state.

Thus, the steering angle error detecting unit 25 decides the error of the steering angle signal V1, V2 generated form the steering angle sensor through the above described way, and can limits the computation of the steering angle by the steering angle computation unit.

Further, in case the steering angle sensor is decided to be erroneous, the steering angle error detecting unit 25 transmits the varied steering angle value of the previous normal steering angle signal to the computation unit by utilizing the previous steering angle sensor signal which is decided to be at normal state by the computation unit, so that the computation unit computes estimated value of the steering angle based upon the varied value of the steering angle.

For this, the steering angle error detecting unit 25 can further comprise a registry which memorizes the signal value of the previous steering sensor signal.

Meanwhile, in case the error in the steering angle sensor signal lasts for predestined time interval, the steering angle error detecting unit decides that the steering angel sensor device is out of order, let this recognized by the driver, and stops the operation of the steering angle sensor device.

In this regard, the time interval of the lasting error which makes the steering angle sensor device be decided to be out of order is set as 0.5˜2 sec, desirably 1 sec.

For this, the recognition unit is further provided in the vehicle which makes the driver recognize the error of the steering angle sensor device, and the steering angle sensor error detecting device operates the recognition unit, and control unit can be further provided which controls the operation of the steering angle sensor.

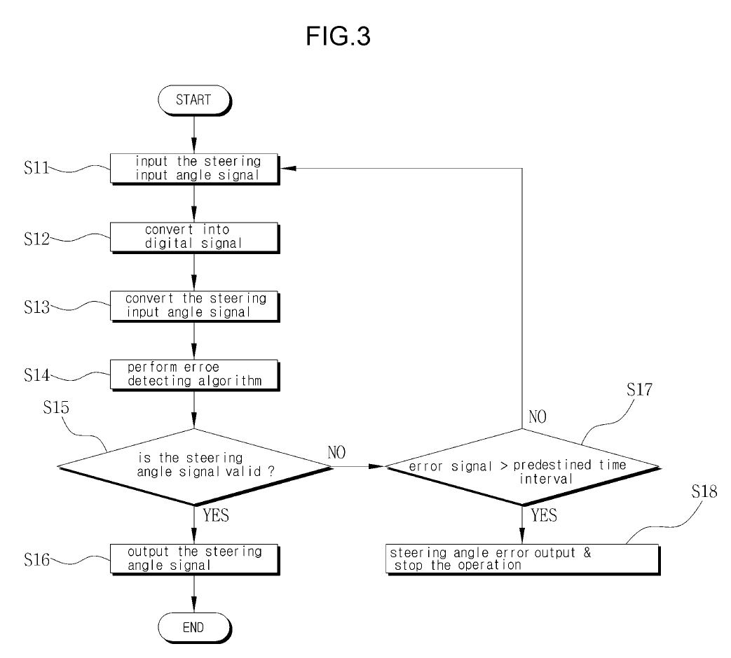

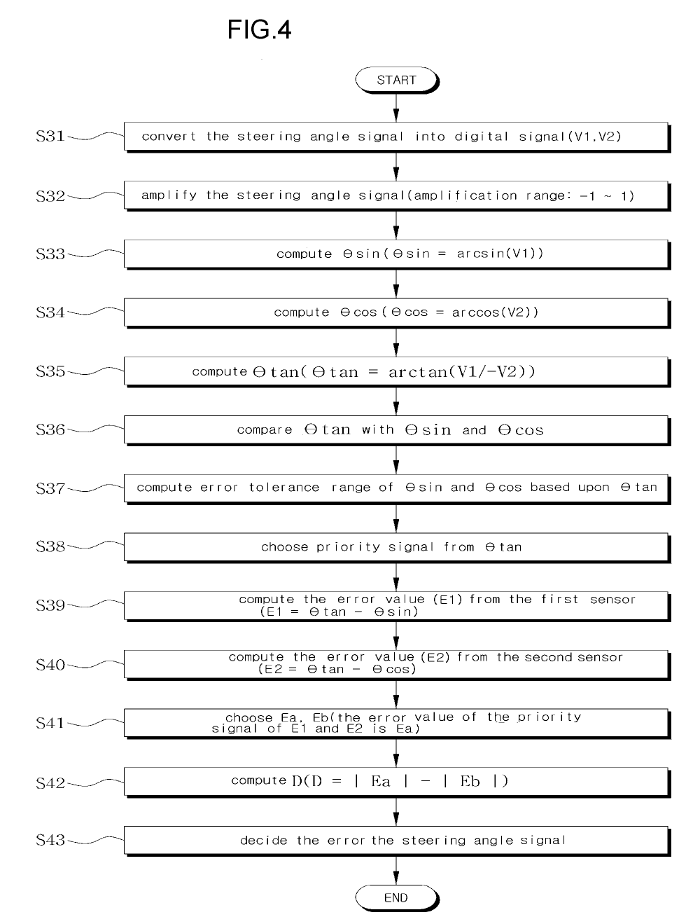

Hereinafter, the embodied error detecting method of the steering angle sensor error detecting device according to the present invention is described in detail with reference to FIGS. 3 and 4.

First, specific steering input angle signal V1, V2 of the steering angle of the steering device from the first sensor and the second sensor is inputted into A/D converter, thereby converted into digital signal (S11, S12).

Then, steering angle is computed by computing the signal inputted by the first sensor out of the steering input angle signal V1, V2 which is converted into digital signal (S13).

Then, it is decided whether or not error exists with regard to the signal converted in the step S13 through the algorithm of the error detecting method of the steering angle sensor according to the present invention as shown in FIG. 4 (S14).

Wherein, the algorithm of the error detecting method of the steering angle sensor can be realized as follows:

The digital signal converted through the step S13 is amplified to predestined range −1˜1 (S31, S32).

Then, the steering angles are computed which form the basis of the comparison with the steering angle from the first and the second sensor by utilizing the equations (1), (2) and (3) (S33, S34, S35).

Then, the steering angles computed through the steps S33, S34 and S35 are compared with one another.

Then, in case the steering angles are not identical with one another through the comparison of the step S36, the error tolerance range of the step S36 is computed on the basis of θₜₐₙ (S37).

Then, prioritized signal is chosen form the steering angle signals out of the first sensor and the second sensor according to the error tolerance range (S38).

Wherein, the steps S36 to S38 can be simplified as batch processing way utilizing the truth table (table 1) for the increase of the processing speed of the steering angle error detecting unit.

Then, the error value of the first sensor is computed through the equation (6) (S39).

Then, the error value of the second sensor is computed through the equation (7) (S40).

Then, priority of the error value Eₐ, E_{b} computed in the steps S39 and S40 is chosen according to the priority of the step S38 (S41).

Then, the decision value D is computed, which decides whether the steering angle signal is at optimized state or at normal state, through equation (8) according to the error value Eₐ, E_{b} whose priority is already decided (S42).

Then, the error of the steering sensor signal and signal state are decided by comparing the error tolerance range computed in each of the above steps, the error value and the decision value, one another (S43).

In case the steering angle sensor signal is decided to be valid in the error detecting algorithm, the steering angle is outputted to the control device of the vehicle (S16).

However, in case the steering angle sensor signal is decided to be erroneous in the error detecting algorithm, it is decided whether the error signal lasts for longer than the predestined time interval (S17).

In this regard, if the error signal lasts for the predestined time interval or longer, the signal for recognizing the error of the steering angle sensor device is outputted and the operation of the steering angle sensor device is stopped (S18).

Moreover, if the error signal lasts for the predestined time interval or shorter, the step S11 is repeated.

Therefore, thanks to the device and method for detecting error of steering angle sensor according to the present invention, it is possible to decide whether or not the steering angle signal measured by the steering angle sensor is erroneous through the algorithm wherein the steering angle signals measured by the first sensor and by the second sensor of the steering sensor are compared with each other in the course of the computation of the steering angle, so that error may be detected.

What is claimed is:

1. The steering angle sensor error detecting device comprising:
Steering angle sensor comprised of the first and the second sensor which sense the angle of the steering device;
A/D converter which converts the steering angle signal from the first sensor and the second sensor into digital signal;
Steering angle computation unit which computes steering angles from the steering angle signals which are converted into digital signal; and
Steering angle error detecting unit which detects error of the steering angle signals by comparing the computed steering angles.

2. The steering angle sensor error detecting device according to claim 1, wherein the steering angle computation unit computes the steering angles through the following equations:
θₜₐₙ=arctan(V₁/−V₂), θₛᵢₙ=arcsin(V₁), θ_{cos}=arccos(−V₂),
and the steering angle computation unit detects the error of the steering angle signals by checking out whether or not the computed steering angles satisfy the relation of θₜₐₙ=θₛᵢₙ=θ_{cos}(θₜₐₙ: basic steering angle, θₛᵢₙ: the first sensor steering angle, θ_{cos}: the second sensor steering angle, V1: the first sensor steering angle signal, V2: the second sensor steering angle signal).

3. The steering angle sensor error detecting device according to claim 2, wherein the steering angle error detecting unit computes error value E1, E2 through the following equations:
E₁=θₜₐₙ−θₛᵢₙ
E₂=θₜₐₙ−θ_{cos},
and further comprises an algorithm through which the error of the steering angle signals is detected based upon the error value E1, E2 (E1: the first sensor error value, E2: the second sensor error value, θₜₐₙ: basic steering angle, θₛᵢₙ: the first sensor steering angle, θ_{cos}: the second sensor steering angle).

4. The steering angle sensor error detecting device according to claim 3, wherein the steering angle error detecting unit further comprises a truth table in which the error tolerance range of the steering angle in accordance with the change of the amplification of the steering angle sensor and the change of the signal offset of the steering angle sensor is shown, and an algorithm through which the error of the steering angle signals is detected based upon the truth table.

5. The steering angle sensor error detecting device according to claim 4, wherein the steering angle error detecting unit computes the optimized state decision value D through the following equation:
D=|Eₐ|−|E_{b}|,
and further comprises an algorithm through which the optimized state of the steering angle signals is decided based upon the decision value D (Eₐ: the error value with higher accuracy of E1 and E2, E_{b}: the error value with lower accuracy of E1 and E2, D: decision value of the optimized state).

6. The steering angle sensor error detecting device according to claim 5, wherein the steering angle error detecting unit further comprises a registry where the signal value of the previous steering angle signal is memorized and transmits the varied steering angle value of the previous steering angle signal memorized in the registry to the computation unit in case the steering angle signal is decided to be erroneous, and the computation unit computes the estimated value of the steering angle based upon the varied steering angle value.

7. The steering angle sensor error detecting device according to claim 1, wherein the steering angle error detecting unit further comprises a device which stops the operation of the steering angle sensor in case the error of the steering angle signal lasts for predestined time interval or longer.

8. The steering angle sensor error detecting method comprising:
a step in which the angle of the steering device is sensed by the steering angle sensor and the steering angle signal is generated;
a step in which the steering angle signal is converted into digital signal by the A/D converter;
a steering angle computing step in which the steering angle is computed from the steering angle signal converted into digital signal by the steering angle computation unit; and
a steering angle error detecting step in which the error of the steering angle signal is detected by comparing the computed steering angle in the steering angle error detecting unit.

9. The steering angle sensor error detecting method according to claim 8, wherein in the steering angle computing step, the steering angle is computed through the following equations:
θₜₐₙ=arctan(V₁/−V₂), θₛᵢₙ=arcsin(V₁), θ_{cos}=arccos(−V₂),
and in the steering angle error detecting step, the error of the steering angle signal is detected by checking out whether or not the computed steering angles satisfy the relation of θₜₐₙ=θₛᵢₙ=θ_{cos}(θₜₐₙ: basic steering angle, θₛᵢₙ: the first sensor steering angle, θ_{cos}: the second sensor steering angle, V1: the first sensor steering angle signal, V2: the second sensor steering angle signal).

10. The steering angle sensor error detecting method according to claim 9, wherein in the steering angle error detecting step, the error value E1, E2 is computed through the following equations:
E₁=θₜₐₙ−θₛᵢₙ
E₂=θₜₐₙ−θ_{cos},
and the step further comprises an algorithm through which the error of the steering angle signal is detected based upon the error value E1, E2 (E1: the first sensor error value, E2: the second sensor error value, θhd tan: basic steering angle, θₛᵢₙ: the first sensor steering angle, θ_{cos}: the second sensor steering angle).

11. The steering angle sensor error detecting method according to claim 10, wherein the steering angle error detecting step further comprises a truth table in which the error tolerance range of the steering angle in accordance with the change of the amplification of the steering angle sensor and the change of the signal offset of the steering angle sensor is shown, and an algorithm through which the error of the steering angle signal is detected based upon the truth table.

12. The steering angle sensor error detecting method according to claim 11, wherein in the steering angle error detecting step, the optimized state decision value D is computed through the following equation:
D=|Eₐ|−|E_{b}|,
and the step further comprises an algorithm through which the optimized state of the steering angle signal is decided based upon the decision value D (Eₐ: the error value with higher accuracy of E1 and E2, E_{b}: the error value with lower accuracy of E1 and E2, D: the optimized state decision value).

13. The steering angle sensor error detecting method according to claim 12, wherein the steering angle error detecting unit further comprises a registry where the signal value of the previous steering angle signal is memorized and transmits the varied steering angle value of the previous steering angle signal memorized in the registry to the computation unit in case the steering angle signal is decided to be erroneous, and a step is further comprised in which the computation unit computes the estimated value of the steering angle based upon the varied steering angle value.

14. The steering angle sensor error detecting method according to claim 8, wherein the steering angle error detecting step further comprises a step in which the operation of the steering angle sensor is stopped in case the error of the steering angle signal lasts for predestined time interval or longer.
